(19) United States
(12) Patent Application Publication
(10) Pub. No.: US 2022/0388296 A1
(43) Pub. Date: Dec. 8, 2022

(54) PRODUCTION OF A COMPOSITE FROM POLYMER SUBSTRATES AND SEALED MICROFLUIDIC CARTRIDGE

(71) Applicant: Hahn-Schickard-Gesellschaft für angewandte Forschung e.V., Villingen-Schenningen (DE)

(72) Inventors: Jan-Niklas KLATT, Freiburg (DE); Tobias HUTZENLAUB, Ettenheim (DE); Stefan HENNIG, Ebringen (DE); Nils PAUST, Freiburg im Breisgau (DE)

(21) Appl. No.: 17/821,068

(22) Filed: Aug. 19, 2022

Related U.S. Application Data
(63) Continuation of application No. PCT/EP2021/052438, filed on Feb. 2, 2021.

(30) Foreign Application Priority Data
Mar. 4, 2020 (DE) 102020202767.6

(51) Int. Cl. B32B 37/06; B32B 3/30; B32B 27/08; B32B 7/027; B01L 3/00

(52) U.S. Cl. CPC B32B 37/06; B32B 3/30; B32B 27/08; B32B 7/027; B01L 3/502707; B32B 27/325

(57) ABSTRACT

In a method for producing a compound of at least two polymer substrates, two polymer substrates each having a connecting surface are provided. At least one of the polymer substrates is coated with a self-assembling polypeptide, at least in the area of the connecting surface. The two polymer substrates are connected by pressing together the connecting surfaces under pressure and at a temperature corresponding to at least the glass transition temperature of the material of one of the polymer substrates at the connecting surface, wherein a diffusion of polymer chains takes place between the connecting surfaces by the self-assembling polypeptide and a solid connection is formed between the two connecting surfaces. A sealed microfluidic cartridge includes a polymer cartridge and a sealing film connected by such a method.

### CROSS-REFERENCE TO RELATED APPLICATIONS

This application is a continuation of copending International Application No. PCT/EP2021/052438, filed Feb. 2, 2021, which is incorporated herein by reference in its entirety, and additionally claims priority from German Application No. 102020202767.6, filed Mar. 4, 2020, which is also incorporated herein by reference in its entirety.

The present invention relates to methods for connecting two polymer substrates, such as may be used to produce sealed microfluidic cartridges, and relates to sealed microfluidic cartridges produced using such methods.

### BACKGROUND OF THE INVENTION

Microfluidics deals with the handling of liquids in the femtoliter to milliliter range. Microfluidic systems are mostly disposable polymer cartridges, as the same have great potential for low-cost mass production. Such cartridges are used with the intention of automating laboratory processes. Standard laboratory processes, such as pipetting, centrifuging, mixing or aliquoting, can be implemented in a microfluidic cartridge. For this purpose, the cartridges include channels for fluid flow as well as chambers for collecting liquids. Applications for microfluidics include laboratory analysis and mobile diagnostics.

Especially in these areas, the usage of microfluidic systems has several advantages, such as low sample and reagent requirements and increased reaction rates. These advantages result primarily from the small size dimensions of microfluidic systems. However, these small dimensions and the associated large surface-to-volume ratios lead to increased non-specific binding of biologically relevant analytes such as proteins, nucleic acids, peptides or bacteria. In particular, the non-specific binding of proteins to the substrate material of microfluidic polymer cartridges poses a particular challenge in the automation of protein-based assays, for which no satisfactory universal solution has been found to date. This is partly due to the fact that to date there are only limited options for permanently and cost-effectively connecting biofunctionalized polymer substrates to form a functional microfluidic cartridge without limiting the functionality of the functionalized surface.

Methods for reducing non-specific binding of proteins in microfluidic systems, for sealing microfluidic polymer cartridges and for coating substrates with self-assembling polypeptides are known. Here, common passivation methods for microfluidic cartridges to avoid protein adsorption will be discussed below.

To reduce non-specific adsorption of biologically relevant analytes in microfluidic systems, blocking the surfaces with BSA, Bovine Serum Albumin, is the most common method. To block the surfaces of microfluidic systems with BSA, an assembled microfluidic cartridge is usually rinsed and incubated with a solution containing BSA. This is followed by at least one additional washing step to remove unbound BSA.

Another very common approach is the application of polymer coatings such as polyethylene glycol (PEG). Such coatings can be applied to many polymer substrates relevant in microfluidics, for example polydimethylsiloxane (PDMS), polymethyl methacrylate (PMMA) or cyclic olefin (co)polymers (COC/COP). They have been shown to significantly reduce the non-specific adsorption of proteins. Depending on the substrate material, the coating process for these types of coatings differs. However, these processes are usually also multi-step processes that first involve activation of the surfaces to be coated, for example with plasma.

It is further known that self-assembling polypeptides are capable of self-assembling at interfaces to form a polypeptide layer, thereby altering the surface characteristics of the functionalized surface, such as the surface energy, roughness/structure, biocompatibility, surface chemistry, etc.

Various self-assembling polypeptides have been described in the literature. Self-assembly is understood to mean that these polypeptides are able, under specific conditions, to independently form a defined structure consisting of several monomers of the polypeptide. Here, the self-assembly is based on interactions between the individual monomers of the polypeptide. In some self-assembling polypeptides, additional interactions occur between the monomers and an interface that influence the self-assembly process. These include, for example, amyloid- and fiber-forming polypeptides (such as spider silk), fungal hydrophobins (such as hydrophobin SC3 from Schizophyllum commune), bacterial hydrophobins (such as BsIA protein from Bacillus subtilis), bacterial surface-layer (S-layer) proteins (such ase.g., the S-layer protein SbsB from Geobacillus stearothermophilus), synthetic self-assembling polypeptides, and combinations (natural, recombinant and synthetic combinations) of these polypeptides, as well as other self-assembling polypeptides known to the person skilled in the art. For example, EP 1 848 733 B1 covers the preparation and usage of hydrophobin fusion proteins, to the class of which H*protein B belongs. From B. von Vacano et al., “Hydrophobin can prevent secondary protein adsorption on hydrophobic substrates without exchange,” Anal Bioanal Chem (2011) 400:2031-2040, it is known that this recombinant hydrophobin can prevent secondary protein adsorption on hydrophobic substrates.

In the production of microfluidic cartridges, substrates are usually sealed, wherein sealing can be understood as the fluid-tight connecting of the substrates, by which fluid channels and fluid chambers in the cartridge are created or closed. It is known to seal microfluidic cartridges made of thermoplastics. Thermoplastics represent an important class of materials for the production of microfluidic cartridges, as they allow the production of low-cost disposable cartridges for laboratory analysis. An essential step in the production of microfluidic cartridges is the sealing of the substrates including the microfluidic structures.

A variety of approaches exist for sealing, which can basically be divided into indirect and direct sealing. The most important indirect sealing variant is adhesive bonding, where the substrates are glued together. The advantage of this approach is its simplicity, which allows the connection of substrates made of different materials. However, a disadvantage of this sealing technique is that not all laboratory processes with adhesively sealed cartridges can be automated, as the adhesives used may inhibit biochemical reactions or subsequent analyses.

Direct sealing processes circumvent this problem by dispensing with adhesives and the resulting microfluidic structures have homogeneous chemical and mechanical characteristics. One example of a direct sealing process is thermal diffusion bonding. In thermal diffusion bonding, the substrates to be connected are brought to a temperature close to or above the glass transition temperature of at least one of the two substrates. To guarantee contact between the substrates, a pressure is often additionally applied. The combination of temperature and pressure results in diffusion of the polymer chains between the surfaces, which then leads to a permanent bond. Since this process does not involve additional solvents, it is an important production method for sealing microfluidic cartridges because the resulting microfluidic channels comprise homogeneous surface characteristics. The usage of thermal diffusion bonding in the field of microfluidics for various thermoplastics is described, for example, in Tsao, C.-W.; DeVoe, D. L., “Bonding of thermoplastic polymer microfluidics,” Microfluid Nanofluid 2009, 6,1-16. Passivation to prevent adsorption of biologically relevant analytes in microfluidic cartridges needs a coating of the original polymer substrate. These coatings can be of different nature, such as biofunctionalized surfaces (blocking with BSA) or polymer coatings (PEG). However, sealing cartridges coated in this way is difficult, because under typical process conditions for direct sealing methods, such as thermal diffusion bonding, these coatings degrade due to the prevailing temperatures and pressures and are thus no longer functional.

The missing possibility to seal functionalized cartridges in a way suitable for mass production has the effect that the cartridges are only coated after they have been sealed. This means that the complete cartridge has to be rinsed several times, which makes mass production difficult.

### SUMMARY

According to an embodiment, a method for producing a compound of at least two polymer substrates may have the steps of: providing two polymer substrates, each comprising a connecting surface, wherein at least one of the polymer substrates is coated with at least one self-assembling polypeptide, at least in the area of the connecting surface; and performing thermal diffusion bonding for connecting the two polymer substrates by pressing the connecting surfaces together under pressure and at a temperature effected by heat input corresponding at least to the glass transition temperature of the material of one of the polymer substrates at the connecting surface, wherein diffusion of polymer chains between the connecting surfaces takes place by the at least one self-assembling polypeptide and a solid connection is formed between the connecting surfaces.

Examples of the present invention provide a method for producing a compound of at least two polymer substrates, comprising: providing two polymer substrates, in particular thermoplastic substrates, each comprising a connecting surface, at least one of the polymer substrates being coated, at least in the area of the connecting surface, with at least one self-assembling polypeptide; and connecting the two polymer substrates by pressing the connecting surfaces together under pressure and at a temperature corresponding at least equal to the glass transition temperature of the material of one of the polymer substrates at the connecting surface, wherein diffusion of polymer chains between the connecting surfaces takes place by the at least one self-assembling polypeptide and a solid connection is formed between the connecting surfaces. In examples, one of the polymer substrates is a polymer cartridge and one of the polymer substrates is a sealing film, such that a sealed microfluidic cartridge is produced as compound partner.

Examples of the present invention provide a sealed microfluidic cartridge produced using a respective method, wherein one of the two polymer substrates is a polymer cartridge and the other of the two polymer substrates is a sealing film.

Thus, examples of the invention provide methods for producing sealed microfluidic cartridges that can comprise a coating of both the sealing film and the cartridge substrate with a self-assembling polypeptide. In examples, surface areas of the polymer substrates outside of the connecting surfaces that come into contact with an analyte during usage of the cartridge are also coated with the self-assembling polypeptide. In examples, the self-assembling polypeptide is configured to selectively change the interaction between surface and analyte by functionalizing these surface areas. In examples, the self-assembling polypeptide is configured to substantially prevent non-specific binding of analytes (such as biomolecules) to the surface areas. In other examples, the self-assembling polypeptide can be configured to specifically immobilize analytes on the functionalized surface areas. In examples, the polymer substrates are fully coated with the self-assembling polypeptide. It has been recognized that despite such coating with a self-assembling polypeptide, sealing by thermal diffusion bonding is possible while maintaining the biochemical functionality of the coating.

Thus, examples of the present invention allow sealing of polymer substrates, at least one of which has been coated with one or more stable layers of self-assembled polypeptides, using a thermodiffusive bonding process. Since the coating is still functional after the sealing process, coated microfluidic cartridges can be produced much more easily than with previously known methods. This is mainly due to the fact that the coating can now be applied before the sealing process, which eliminates the need for time-consuming coating with several incubation and washing steps in already sealed cartridges. Further, high stability of the coating compared to conventional coatings such as BSA or PEG towards solvents and temperatures, as well as a long-term stability can be achieved. Thus, examples of the present disclosure are suitable for mass production.

It was surprisingly realized that a functionalized surface consisting of self-assembled polypeptides was still functional after a thermal diffusion bonding process using temperatures above the glass softening temperature of the polymer substrate. This was not anticipated, as it would have been expected that the polypeptides would denature and the coating would change its characteristics as a result of the thermal diffusion bonding process. Further, it was surprisingly realized that despite the coating with the self-assembling polypeptide on the connecting surfaces, sufficiently high sealing strength is achieved to process microfluidic cartridges without causing delamination and thus leaks.

### BRIEF DESCRIPTION OF THE DRAWINGS

Embodiments of the present invention will be detailed subsequently referring to the appended drawings, in which:

FIGS. 1A and 1B are schematic cross-sectional views of two polymer substrates before connecting and after connecting the same to explain an example of a method according to the present disclosure;

FIGS. 2A to 2C are schematic cross-sectional views illustrating another example of a method according to the present disclosure;

FIGS. 3A and 3B are schematic representations of an example of a system for performing thermal diffusion bonding; and

FIG. 4 is a schematic representation of examples of possible scenarios in which methods disclosed herein can be used.

### DETAILED DESCRIPTION OF THE INVENTION

Examples of the present invention will be described in detail below, using the accompanying drawings. It should be noted that identical elements or elements having the same functionality can be provided with the same or similar reference numbers, and a repeated description of elements provided with the same or similar reference numbers is typically omitted. Descriptions of elements having the same or similar reference numbers are interchangeable. In the following description, many details are described to provide a more thorough explanation of examples of the invention. However, it will be apparent to those skilled in the art that other examples can be implemented without these specific details. Features of the various examples described can be combined with each other unless features of a corresponding combination are mutually exclusive or such a combination is explicitly excluded.

Before discussing embodiments of the present invention in more detail, some terms will first be explained.

A polypeptide is a macromolecule consisting of 10 to 20,000 amino acids linked by peptide bonds.

Self-assembling polypeptides are polypeptides that can form layers on their own at interfaces, changing certain characteristics of the interface. The ability of a polypeptide to self-assemble at certain interfaces depends on the characteristic of the interface and the self-assembling polypeptide. For example, for hydrophobin H*protein B, stable layers can form at hydrophobic surfaces. Accordingly, the self-assembling polypeptides are self-assembling with respect to the material of the interface to which the coating is applied.

The term analyte should be understood to mean those substances contained in a sample about which a statement is to be made in a chemical analysis. Relevant analytes can be, for example, proteins, peptides, nucleic acids, metabolites, secondary metabolites, vitamins, pigments, cells (human, plant or animal cells as well as fungi, bacteria or mycoplasmas) and viruses. In a broader sense, the term analyte also includes nanomaterials such as nanoparticles, quantum dots and carbon nanotubes.

The term “thermodiffusive bonding” or thermal diffusion bonding of polymer substrates refers to a method based on bringing one of the substrates to be connected to a temperature near or above the glass transition temperature. The elevated temperature and the pressing of the hot substrates against each other with pressure results in sufficient mobility of the polymer chains so that a diffusive process begins by which the two substrates bond.

The term glass transition temperature refers to a temperature at which amorphous polymers completely or partially transition from a brittle state to a highly viscous, flexible range. In the case of thermoplastics, this transition is reversible.

The term “sealing film” means an unstructured substrate connected to a structured polymer substrate containing a microfluidic structure, also referred to herein as a polymer cartridge.

The term microfluidic structures, system or cartridges means those that are configured, i.e. comprise appropriate dimensions, to handle fluids in the femtoliter to milliliter range.

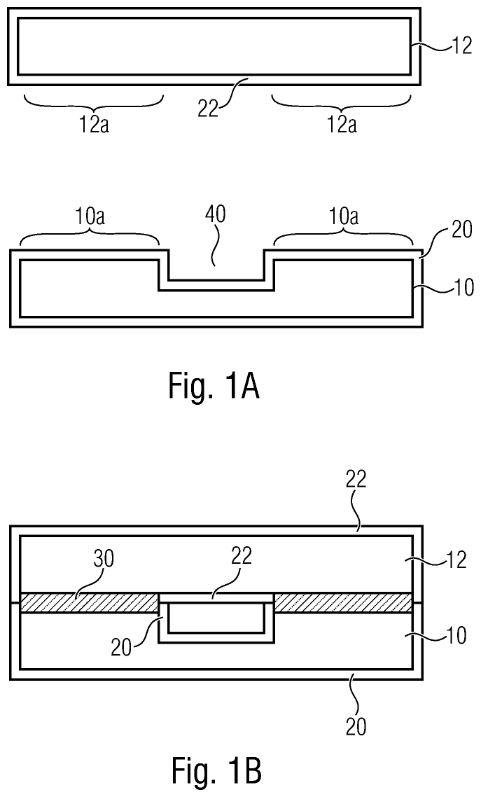

As shown in FIG. 1A, in an example of a method according to the present disclosure, a first polymer substrate 10 and a second polymer substrate 12 are provided. It should be noted here that hatching is omitted in FIGS. 1A and 1B for illustrative purposes. The first polymer substrate 10 comprises one or more connecting surfaces 10a, and the second polymer substrate 12 comprises one or more connecting surfaces 12a. The connecting surfaces 10a and 12a are surfaces where the polymer substrates 10 and 12 are to be connected. The first polymer substrate 10 comprises a coating 20 of a self-assembling polypeptide at least in the area of the connecting surface 10a. The second polymer substrate 12 comprises a coating 22 of a self-assembling polypeptide at least in the area of the connecting surface 12a. In other examples, only one of the polymer substrates 10, 12 comprises a coating of a self-assembling polypeptide.

In the example shown, both polymer substrates 10 and 12 are fully coated with the self-assembling polypeptide. This can be done, for example, by immersing the polymer substrates 10 and 12 in a solution containing the self-assembling polypeptide. In other examples, only the connecting surfaces are coated with the self-assembling polypeptide. In other examples, the connecting surfaces and areas of the polymer substrates that come into contact with analytes during usage are coated with the self-assembling polypeptide.

As shown in FIG. 1B, the two polymer substrates 10 and 12 are conencted by pressing the connecting surfaces 10a and 12a together under pressure and at a temperature corresponding at least to the glass transition temperature of the material from one of the polymer substrates at the connecting surface 10a, 12a. In this process, diffusion of polymer chains between the connecting surfaces 10a, 12a by the self-assembling polypeptide takes place and a solid connection is formed between the connecting surfaces 10a, 12a. Thus, thermal diffusion bonding takes place through the coatings 20 and 22. This results in a connecting area 30, illustrated hatched in FIG. 1B, in which diffusion of polymer chains from at least one of the polymer substrates 10, 12 through the coatings 20, 22 takes place, such that the polymer substrates are firmly connected to each other in this area. In the remaining areas, the coatings 20, 22 remain unchanged.

In the example shown in FIGS. 1A and 1B, the polymer substrate 10 comprises a recess 40 whose surfaces are also provided with the coating 20. By connecting the polymer substrates 10, 12, this recess is covered by the polymer substrate 12. For example, the recess can represent fluidic structures, such as one or more fluid channels and/or one or more fluid chambers. As can be seen in FIG. 1B, the surfaces defining these fluidic structures are provided with the coating 20, 22, such that an interaction between the surfaces and analytes in contact therewith can be specifically changed. In other examples, the two polymer substrates are planar on the side where connecting takes place. In other examples, both polymer substrates can have recesses on the side where connecting takes place.

In examples, the at least one polypeptide is a single polypeptide. In examples, the at least one polypeptide is a mixture of different self-assembling polypeptides.

In examples, two polymer substrates are connected to each other. In other examples, a larger number of polymer substrates can be appropriately connected to each other. In examples, a compound of a cartridge and two sealing films, which can consist of different materials, can be produced. For example, the sealing films can seal different areas of the cartridge, which may be on the same side or on different sides of the cartridges.

In examples, the pressure at which the polymer substrates 10, 12 are pressed together is at least 1.2 bar and pressing together takes place for a period of at least 1 second. This allows a secure connection to be formed between the polymer substrates.

In examples, one of the two polymer substrates, e.g., the polymer substrate 10, is a microfluidic polymer cartridge and the other of the two polymer substrates, e.g., the polymer substrate 12, is an unstructured sealing film. The microfluidic polymer cartridge can have a fluidic structure, e.g., recess 40, that is open to the side that is to be connected to the other polymer substrate. During connecting, the fluidic structure can then be sealed by the sealing film. Thus, examples provide a method for producing a sealed microfluidic polymer cartridge or a microfluidic polymer cartridge produced by such a method, wherein a sealed, fully functionalized cartridge (all surfaces of the microfluidic structure are coated) can be obtained without the need for treating (for example, rinsing) the sealed cartridge in a further step after assembly of the cartridge.

The polymer substrates 10, 12 comprise a material with a surface that enables self-assembly of the self-assembling polypeptide. In examples, the polymer substrates are thermoplastic substrates comprising a thermoplastic material. In examples, both polymer substrates consist of the same material. In examples, the polymer substrates consist of different materials. In examples, the polymer substrates comprise a cyclic olefin copolymer. In examples, the polymer substrates comprise a material selected from the group consisting of polydimethylsiloxane (PDMS), polymethyl methacrylate (PMMA), or cyclic olefin (co)polymers (COC/COP).

In examples of the present disclosure, the self-assembling polypeptides selected for coating are those that are capable of forming robust polypeptide layers and that are not detached from the surface by exposure to certain chemicals (e.g., acids, bases, detergents, organic solvents) and/or elevated temperature. In examples, the polypeptide layers are selected to maintain their characteristics even after exposure to these factors. Thus, it can be achieved that the self-assembling polypeptides are not detached from the surface during sealing and usage of the microfluidic cartridge. Advantageously, contamination of a biological sample by self-assembling polypeptides (or their cleavage products) can thus be prevented.

In examples, the coating of the self-assembling polypeptide may be a monolayer, i.e., only one layer of polypeptide on the substrate, a bilayer, i.e., two layers of polypeptide on the substrate, or a multilayer, i.e., three or more layers of the polypeptide on the substrate. It has been found that for the above purposes, the self-assembling polypeptides according to the present disclosure can be natural polypeptides (e.g., polypeptides isolated from natural organisms), recombinant polypeptides (e.g., polypeptides isolated from recombinant organisms), synthetic polypeptides (e.g., polypeptides synthesized in a chemical synthesis method), modified polypeptides (e.g., post-translationally modified polypeptides or chemically modified polypeptides), and a combination of these options. In examples of the invention, the coating is a monolayer, as this allows for greater reliability of the thermal diffusion process.

It has been found that hydrophobins from filamentous fungi and their recombinant and synthetic derivatives are particularly advantageous for the above purposes. Hydrophobins are comparatively small polypeptides (approx. 100 amino acids) with an amphiphilic protein structure, i.e. the protein has a hydrophilic and a hydrophobic surface domain. As a result, hydrophobins are among the proteins with the highest surface activity. At a hydrophilic-hydrophobic interface, the individual hydrophobin monomers interact with both the interface and other monomers and thus form a stable polypeptide monolayer (self-assembly). Due to the amphiphilic character of the hydrophobins, among others the surface energy of the functionalized surface is amended. Based on the amino acid sequence and the characteristics of the polypeptide monolayers, hydrophobins are divided into two classes (class I and class II), with class I hydrophobins forming particularly stable protein layers that cannot be detached from the functionalized surface even by the action of detergents, acids, alkalis or high temperatures. Therefore, hydrophobins, especially class I hydrophobins, are particularly advantageous for the present disclosure.

In examples, the self-assembling polypeptide is a recombinant hydrophobin and, in particular, the hydrophobin H*protein B. With such a self-assembling polypeptide, on the one hand, analytes can be reliably prevented from adsorbing on the surface coated therewith, and on the other hand, a reliable thermal diffusion process can take place. Thus, in such a configuration of the disclosure, non-specific adsorption of analytes from a biological sample on the surface of a microfluidic cartridge can be prevented.

In other examples, depending on the surface functionality to be achieved, other self-assembling polypeptides may be used. Examples include amyloid- and fiber-forming polypeptides (such as spider silk), fungal hydrophobins (such as hydrophobin SC3 from Schizophyllum commune), bacterial hydrophobins (such as the BsIA protein from Bacillus subtilis), bacterial surface layer (S-layer) proteins (such as.e.g., the S-layer protein SbsB from Geobacillus stearothermophilus), synthetic self-assembling polypeptides, and combinations (natural, recombinant and synthetic combinations) of these polypeptides, as well as other self-assembling polypeptides known to the person skilled in the art.

In examples, the self-assembling polypeptide is selected to specifically change an interaction between the surface coated therewith and the analytes with respect to specific analytes. In examples, the self-assembling polypeptide is selected to prevent non-specific binding of the analytes to the surface. In examples, the self-assembling polypeptide is selected to cause immobilization of the analytes on the surface coated therewith.

In examples, at least one of the two polymer substrates comprises a first layer and a second layer, wherein the connecting surface of that substrate is disposed on the second layer, and wherein the second layer has a lower glass transition temperature than the first layer and wherein the temperature at which compression takes place is higher than the glass transition temperature of the second layer. In such examples, further, the temperature at which compression takes place may be lower than the glass transition temperature of the first layer.

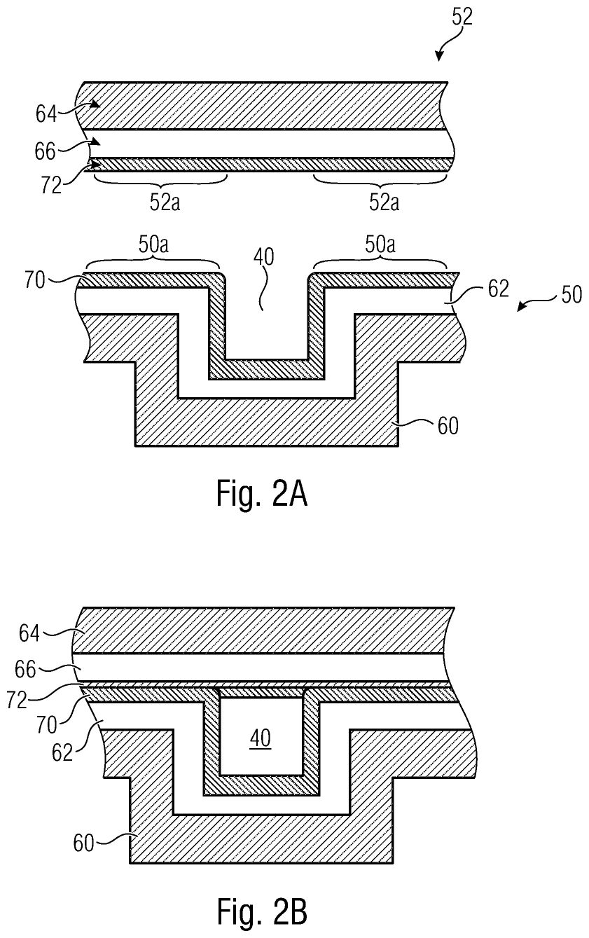

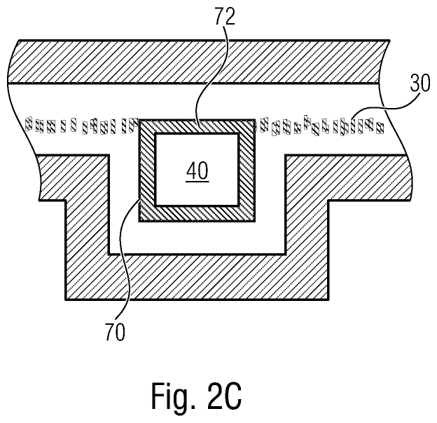

FIGS. 2A to 2C schematically show cross-sectional views to explain one such example in which a first polymer substrate 50 and a second polymer substrate 52 are provided. Here, FIGS. 2A to 2C each show only sections of the polymer substrates 50 and 52. The first polymer substrate 50 comprises a first layer 60 and a second layer 62. The second polymer substrate 52 comprises a first layer 64 and a second layer 66. The first polymer substrate 50 comprises one or more connecting surfaces 50a, and the second polymer substrate 52 comprises one or more connecting surfaces 52a. A coating 70 of a self-assembling polypeptide is provided on the first polymer substrate 50, and a coating 72 of a self-assembling polypeptide is provided on the second polymer substrate 52. Again, in this example, only one of the polymer substrates 50, 52 could be provided with a coating and the coating(s) could again be provided over the entire surface or in sections. The first polymer substrate 50 again comprises a recess 40.

The polymer substrates 50, 52 are brought together so that the connecting surfaces 50a and 52a are aligned with each other, as shown in FIG. 2B. Subsequently, the polymer substrates 50, 52 are subjected to pressure and temperature to connect the same by thermal diffusion. The resulting structure, in which the surfaces of the cavity are covered by the coatings 70, 72, is shown in FIG. 2C. In the area of the connecting surfaces 50a, 52a, this again results in a connecting area 30 in which the polymer substrates 50, 52 are firmly connected to each other.

Layers 60 and 64 can consist of a first thermoplastic material, and layers 62 and 66 can consist of a second thermoplastic material. The second thermoplastic material has a lower glass transition temperature than the first thermoplastic material. The first thermoplastic material may have a glass transition temperature that is higher than the temperature used to connect the polymer substrates 50 and 52 to each other. As a result, increased stability of the compound can be obtained during connecting.

Also in the method explained with reference to FIGS. 2A to 2C, the polymer substrates can be parts of a microfluidic cartridge so that a sealed microfluidic cartridge is obtained after connecting.

In examples, the first and second polymeric substrates 50, 52 may be multilayer COC films coated with the hydrophobin H*protein B, wherein the polymeric substrate 50 is a polymeric cartridge and the polymeric substrate 52 is a sealing film. In this example, the microfluidic cartridge 50 consist of a compound of two cyclic olefin copolymer layers 62 and 60 (COC 8007/6013) that differ in terms of their glass transition temperature (78° C./135° C.). The sealing film 52 can consist of a compound of two cyclic olefin copolymer layers 66 and 64 made of the same materials as the layers 62 and 60 or different materials. Basically, the glass transition temperature of the carrier layer 60 or 64 is thereby higher than the glass transition temperature of the connecting layer 62 or 64, which comprises the connecting surfaces, which can also be referred to as the sealing layer. The combination of two layers or films with different glass transition temperatures makes it possible to ensure sufficient mobility of the polymer chains in the connecting layer by selectively choosing the process temperature during the diffusive bonding process. At the same time, the dimensional stability of the microfluidic structures can be ensured by the carrier layer.

The process temperature T_{process} can be selected according to the following formula to be higher than the glass transition temperature TG_{sealing layer} and lower than the glass transition temperature of the carrier layer TG_{carrier layer}:

TG_{sealing layer}<T_{process}<TG_{carrier layer}

In examples, the coating of the first and second polymer substrates can take place as follows, for example when the substrates consist of a COC material. First, a solution having a concentration of 1 g/I is prepared by dissolving 50 mg of H*protein B in 50 ml of DI water. The solution is stirred at room temperature for 30 minutes and then centrifuged at 2000 g for two minutes. The clear supernatant is transferred to a new reaction tube and adjusted to a final concentration of 10 μg/ml in 0.5× phosphate buffered saline solution (PBS). In examples, the final concentration of the solution should be in a range of 1 μg/ml and 35 μg/ml. The polymer substrates, i.e. the cartridges as well as sealing films, are then immersed in the H*Protein B solution and incubated at room temperature for at least 30 minutes. Both cartridges and sealing films can be rinsed with PBS as well as water after coating to remove excess H*protein B. Concentration of the solution in the above range can, on the one hand, reliably prevent adsorption of proteins to the resulting coating, and, on the other hand, result in high sealing strength.

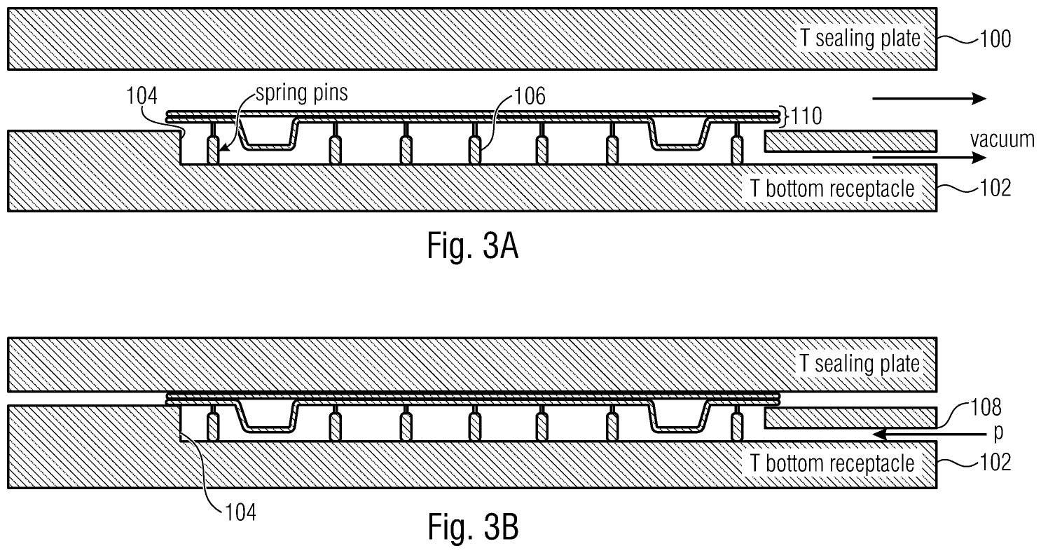

The appropriately coated polymer substrates can then be connected to each other using a thermal diffusion bonding process. The basic mode of operation of thermal diffusion bonding has already been explained above. A specific example of a process for thermal diffusion bonding of multilayer COC films is illustrated in FIGS. 3A and 3B.

For an exemplary sealing process performed using thermal diffusion bonding, the coated polymer substrates (cartridge and sealing film) are properly aligned with each other and then placed in a sealing system, as shown in FIG. 3A. The sealing system comprises an top sealing plate 100 and a receptacle 102. The receptacle 102 comprises a recess 104 in which spring pins 106 are disposed. The spring pins 106 project upwardly from the recess 104. The top sealing plate 100 can be heated to a temperature T_{sealing plate} and the receptacle 102 can be heated to a temperature T_{bottom receptacle}. The temperature T_{sealing plate} can be, for example, 115° C. and the temperature T_{bottom receptacle} can be, for example, 95° C. The temperatures are selected such that during subsequent bonding, the temperature of the connecting layers is brought to at least their glass transition temperature. A pressure port 108 is further provided in the receptacle 102, through which a positive pressure can be generated in the recess 104. Further, a vacuum can be generated in a chamber in which the sealing plate 100 and the receptacle 102 are disposed.

In operation, for sealing the coated polymer substrates, the cartridge and sealing film arrangement 110 is placed on the spring pins, as shown in FIG. 3A. The outer edges of the arrangement 110 project beyond the outer edges of the recess 104. The top sealing plate 100 is lowered and presses the arrangement 110 against the top surface of the receptacle 102 against the force of the spring pins 106, as shown in FIG. 3B. In doing so, the arrangement 110 closes the recess 104 in the lower sealing plate 102 towards the top so as to generate an enclosed cavity in which excess pressure can be generated via the pressure port 108. The top sealing plate 100 and the receptacle 102 are heated. In one example, the top plate is heated to 115° C. and the receptacle is heated to 95° C. to thermodiffusively bond the COC composite films of the arrangement 110. After the top sealing plate 100 is lowered and the chamber is sealed, the chamber is evacuated.

Subsequently, excess pressure is applied via the pressure port 108 to the recess 104 closed towards the top by the arrangement 110, so that a maximum contact pressure is achieved, for example a contact pressure of 15 kN. The structured cartridge side is thereby pressed against the sealing film under pressure, for example a pressure of 1.2 bar, in order to achieve uniform contact. After a contact pressure time, which can be 5 seconds for example, the cartridge and sealing film have been thermodiffusively bonded, the chamber can be ventilated again and the sealed arrangement can be removed after the top sealing plate 100 has been raised again.

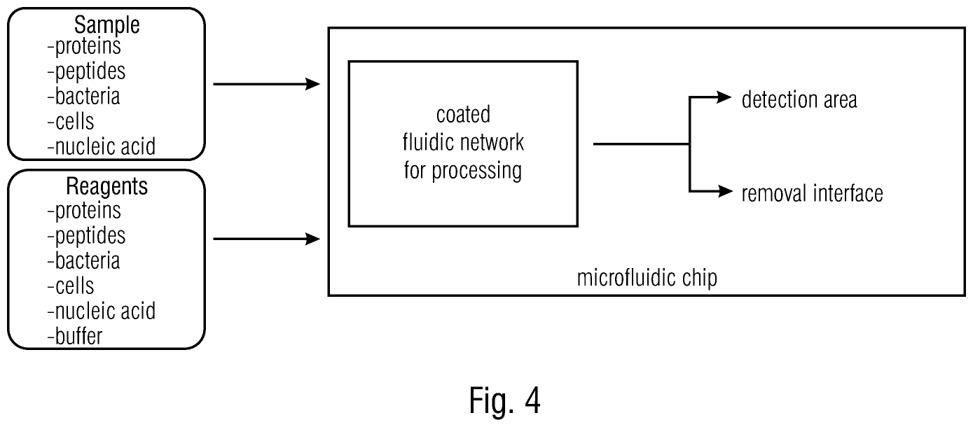

Possible applications of the processes described herein are shown schematically in FIG. 4. One possible application of the methods described herein is the sealing of microfluidic polymer cartridges previously coated with a self-assembling polypeptide, e.g., a hydrophobin. Such sealed microfluidic cartridges, as shown in FIG. 4, can be used for processing samples or reagents that can contain proteins, peptides, bacteria, cells, nucleic acids and/or buffers. In this context, the term processing includes all steps to perform a bio-chemical assay. In such a scenario, the sealed microfluidic cartridge is coated, for example, to prevent loss of the sample or reagents in the microfluidic structure in that the coating of self-assembling polypeptide prevents the sample or analytes of the sample from adhering to the microfluidic structures. In other applications, the self-assembling polypeptides can be selected to provide a different functionality, for example, to immobilize analytes in the microfluidic structures or specific areas of the microfluidic structures. In this regard, the microfluidic structures may form a fluidic network that is appropriately coated and through which all or part of the sample or reagents are passed. The cartridge can thereby also be referred to as a microfluidic chip. The aim of the processing is, for example, to bring the processed sample into a detection area on the sealed microfluidic cartridge where detection takes place, or to convey the processed sample into a suitable removal interface, such as a chamber or a transition into a reaction tube.

Thus, examples of the present disclosure provide a method in which two polymer substrates, at least one of which is coated with a self-assembling polypeptide, are thermodiffusively bonded together under the influence of temperature. In examples, the two substrates are pressed against each other at a pressure of at least 1.2 bar for a period of at least 1 second. The heat input during the sealing process causes the temperature of the substrate during the sealing process to correspond at least to the glass transition temperature of the substrate material, such that there is sufficient mobility of the molecules in the polymer substrate such that when the substrates, at least one of which is appropriately coated, are brought together, a solid connection between the substrates is formed through the coating with the self-assembling polypeptide. In examples, at least one of the two substrates can comprise a layer having a lower glass transition temperature and a layer having a higher glass transition temperature to greatly increase the mobility of the surface molecules upon heating. The second layer with a higher glass transition temperature can simultaneously maintain dimensional stability.

Thus, examples of the present disclosure enable biofunctional polymer substrates to be permanently and inexpensively connected to form a functional microfluidic cartridge without limiting the functionality of the functionalized surface. This is possible by coating with a self-assembling polypeptide before the polymer substrates, in particular made of a thermoplastic material, are connected through the coating of self-assembling polypeptide by a thermal diffusion bonding process. Thus, in particular, surfaces of microfluidic structures in microfluidic cartridges can be coated, for example, by completely coating parts of the cartridge accordingly and then connecting the parts of the cartridge by thermal diffusion bonding.

Although in each of the above examples a structured polymer cartridge is connected to a sealing film, in alternative examples other components of a cartridge can be connected together, for example a first structured part of the later cartridge to a second structured part of the later cartridge. Thus, in examples, two structured or two unstructured polymer cartridge parts can be connected to each other by a corresponding method.

Although some aspects of the present disclosure have been described as features related to an apparatus, it is obvious that such a description may also be considered as a description of corresponding method features. Although some aspects have been described as features related to a method, it is obvious that such a description may also be considered as a description of corresponding features of an apparatus or functionality of an apparatus.

The above disclosure provides illustrations and descriptions, but it is not intended that the same be exhaustive or that the implementations be limited to the precise form disclosed.

Modifications and variations are possible with respect to the above disclosure or may be obtained from practice of the implementations. Although certain combination of features are recited in the claims and/or disclosed in the description, it is not intended that these features limit the disclosure of possible implementations. In fact, numerous of these features may be combined in ways not specifically recited in the claims and/or disclosed in the description.

Although each of the dependent claims recited below may depend directly on only one or some of the claims, the disclosure of possible implementations encompasses each dependent claim in combination with all other claims in the set of claims.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Method for producing a compound of at least two polymer substrates, comprising:
providing two polymer substrates, each comprising a connecting surface, wherein at least one of the polymer substrates is coated with at least one self-assembling polypeptide, at least in the area of the connecting surface; and
performing thermal diffusion bonding for connecting the two polymer substrates by pressing the connecting surfaces together under pressure and at a temperature effected by heat input corresponding at least to the glass transition temperature of the material of one of the polymer substrates at the connecting surface, wherein diffusion of polymer chains between the connecting surfaces takes place by the at least one self-assembling polypeptide and a solid connection is formed between the connecting surfaces.

2. Method according to claim 1, wherein the pressure is at least 1.2 bar and pressing together takes place for a period of at least one second.

3. Method according to claim 1, wherein both polymer substrates are coated with the at least one self-assembling polypeptide.

4. Method according to claim 1, wherein providing the two polymer substrates comprises immersing at least one of the polymer substrates into a solution with the at least one self-assembling polypeptide to coat the at least one of the polymer substrates with the at least one self-assembling polypeptide.

5. Method according to claim 1, wherein at least one of the two polymer substrates comprises a first layer and a second layer, wherein the connecting surface of this substrate is disposed on the second layer, and wherein the second layer comprises a lower glass transition temperature than the first layer, and wherein the temperature at which pressing together takes place is higher than the glass transition temperature of the second layer.

6. Method according to claim 5, wherein the temperature at which pressing together takes place is lower than the glass transition temperature of the first layer.

7. Method according to claim 1, wherein at least one of the two polymer substrates is a microfluidic polymer cartridge in which at least one fluidic structure that is open towards one side of the microfluidic polymer cartridge is formed.

8. Method according to claim 1, wherein one of the two polymer substrates is an unstructured sealing film.

9. Method according to claim 8, wherein the other one of the two polymer substrates is a or the microfluidic polymer cartridge where at least one fluidic structure that is open towards the side of the microfluidic polymer cartridge is disposed on the connecting surface, wherein the at least one fluidic structure is closed by the sealing film during connecting.

10. Method according to claim 1, wherein the at least one self-assembling polypeptide comprises a natural polypeptide, a recombinant polypeptide, a synthetic polypeptide, a modified polypeptide or a combination of these polypeptides.

11. Method according to claim 10, wherein the at least one self-assembling polypeptide is a hydrophobin of filamentous fungi or a recombinant or synthetic derivative.

12. Method according to claim 1 for producing a sealed microfluidic cartridge, wherein one of the two polymer substrates is a or the polymer cartridge and the other one of the two polymer substrates is a or the sealing film.
